(19) United States
(12) Patent Application Publication
(10) Pub. No.: US 2002/0035146 A1
(43) Pub. Date: Mar. 21, 2002

(54) Antifungal compounds and compositions and antifungal use thereof

(76) Inventor: David Hamilton Young, Ambler, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 09/906,975

(22) Filed: Jul. 17, 2001

Related U.S. Application Data
(60) Provisional application No. 60/222,682, filed on Aug. 2, 2000.

(51) Int. Cl. A01N 37/34; A01N 33/00; A01N 31/14

(52) U.S. Cl. 514/519; 514/579; 514/715

(57) ABSTRACT

The present invention relates to the use of certain compounds, known to inhibit the response of plants to ethylene, for the control of phytopathogenic fungi. The compounds are substituted cyclopropenes.

The present invention relates to the use of certain compounds, known to inhibit the response of plants to ethylene, for the control of phytopathogenic fungi. The compounds are substituted cyclopropenes.

It has been reported that ethylene induces susceptibility of carnation flowers to attack by B. cinerea and that compounds which suppress ethylene biosynthesis or inhibit its action such as silver thiosulfate (“STS”), aminooxyacetic acid (“AOA”), and aminoethoxyvinylglycine (“AVG”) decreased disease severity in rose petals and leaves inoculated with Botrytis cinerea. (see Y. Elad, Ann. Appl. Biol. 113, 589-598 (1988)). Treatment of cut rose flowers with STS or AOA significantly decreased disease incidence during subsequent incubation, suggesting a treatment for reducing grey mold damage in flowers during transport. Elad suggested that increased amounts of ethylene produced in the atmosphere of cut flowers induces susceptibility to B. cinerea by enhancing senescence of the plant tissue. Ethylene has also been shown to increase the development of Fusarium root disease on Douglas fir and enhanced infection of tomato by Fusarium oxysporum. (see J. H. Graham and R. G. Linderman, Canadian Journal of Botany 59, 149-155(1981) and R. P. Collins and R. P. Scheffer, Phytopathology 48, 349-355 (1958)) It has also been suggested that ethylene resulting from Fusarium infection inhibits the synthesis of a fungitoxic substance (tulipalin A) in tulip bulbs. (see J. C. M. Beijersbergen and B. H. H. Bergman, Acta Bot. Neerl. 22, 172 (1973)). There is also evidence that ethylene may have inhibitory effects on rot development on infected fruits and other plant organs. (see G. E. Brown and C. R. Barmore, Phytopathology 67, 120-123 (1977)). These apparently contradictory results may be due to differences in the timing of ethylene exposure and other environmental factors. What is still needed however are materials which will both inhibit a plant's response to ethylene and at the same time exert a direct fungitoxic effect on phytopathogenic fungi.

Substituted cyclopropenes are known inhibitors of the ethylene response in plants. (see U.S. Pat. No. 5,518,988). We have discovered that certain substituted cyclopropenes also have a direct toxic effect on a number of phytopathogenic fungi and that such compounds, and compositions thereof, are useful as agents to control plant fungal infections.

This invention, therefore, provides a method to control phytopathogenic fungi, comprising applying to the locus of the fungi a fungicidally effective amount of a compound of formula I:

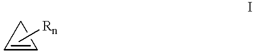

wherein:

a) n is from 1 to 4, preferably from 1 to 2, more preferably 1; and

b) each R is independently hydrogen, cyano; halogen, hydroxy; carboxy; (C₁-C₂₀)alkyl, optionally substituted independently with from 1 to 3 halogen, hydroxy, cyano, (C₁-C₂₀)alkoxy, or amino; (C₁-C₂₀)alkoxy, optionally substituted independently with from 1 to 3 halogen, hydroxy, cyano, (C₁-C₂₀)alkoxy, or amino; (C₂-C₂₀)alkenyl, optionally substituted independently with from 1 to 3 halogen, hydroxy, cyano, (C₁-C₂₀)alkoxy, or amino; (C₂-C₂₀)alkynyl, optionally substituted independently with from 1 to 3 halogen, hydroxy, cyano, (C₁-C₂₀)alkoxy, or amino; (C₁-C₂₀)alkoxycarbonyl(C₁-C₂₀)alkyl, optionally substituted independently with from 1 to 3 halogen, hydroxy, cyano, (C₁-C₂₀)alkoxy, or amino; or amino; provided that the total number of non-hydrogen atoms in each R does not exceed 21; and

its enantiomers, stereoisomers, and agronomically acceptable salts; or a composition comprising one or more of the compounds and an agronomically acceptable carrier.

Preferably, each R is independently hydrogen, cyano; halogen, hydroxy; carboxy; (C₁-C₁₀)alkyl, optionally substituted independently with from 1 to 3 halogen, hydroxy, cyano, (C₁-C₁₀)alkoxy, or amino; (C₁-C₁₀)alkoxy, optionally substituted independently with from 1 to 3 halogen, hydroxy, cyano, (C₁-C₁₀)alkoxy, or amino; (C₂-C₁₀)alkenyl, optionally substituted independently with from 1 to 3 halogen, hydroxy, cyano, (C₁-C₁₀)alkoxy, or amino; (C₂-C₁₀)alkynyl, optionally substituted independently with from 1 to 3 halogen, hydroxy, cyano, (C₁-C₁₀)alkoxy, or amino; (C₁-C₁₀)alkoxycarbonyl(C₁-C₁₀)alkyl, optionally substituted independently with from 1 to 3 halogen, hydroxy, cyano, (C₁-C₁₀)alkoxy, or amino; or amino; provided that the total number of non-hydrogen atoms in each R does not exceed 11. More preferably, each R is independently (C₁-C₁₀)alkyl; (C₁-C₁₀)alkoxy; (C₂-C₁₀)alkenyl; or (C₂-C₁₀)alkynyl, halogen, cyano, amino, or carboxy. Even more preferably, each R is (C₁-C₁₀)alkyl. Most preferably, each R is methyl.

When n is 1, the R substituent is preferably on the 1-position of the cyclopropenyl ring. When n is 2, the R substituents are preferably in the 1,2-position or the 3,3-position; more preferably the 1,2-position.

The term “locus” means the fungus itself, the environment in which fungi grow or are found, or an environment in which the compound may be released such that it subsequently comes into contact with the fungi.

The terms “alkyl”, “alkenyl”, “alkynyl”, and “alkoxy” include both straight and branched chain groups. The term “halogen” means fluoro, chloro, bromo, and iodo. The term “amino” includes primary, secondary, and tertiary amino groups wherein the substituent groups on the secondary and tertiary amino include (C₁-C₁₀)alkyl.

The term “fungicidally effective amount” means an amount sufficient to provide the desired level of control of the fungi. The term “agronomically acceptable carrier” means any substance which can be used to dissolve, disperse or diffuse the compound in a composition without impairing the compound's effectiveness and which by itself has no significant detrimental effect on the soil, equipment, desirable plants, or agronomic environment.

Compounds of formula I are prepared according to the following general preparative methods:

Cyclopropenes substituted in the 1-position can be prepared by the method of Baird, M., et. al., J. Chem. Soc. Perkin Trans. I, (1986), 1845-1853. This method comprises addition of a dibromocarbene to a 1-substituted vinyl bromide which forms a 1-substituted-1,2,2-tribromocyclopropane. Subsequent treatment of the 1-substituted-1,2,2-tribromocyclopropane with methlylithium provides the desired 1-substituted cyclopropene.

Similarly, 1,3-Disubstituted cyclopropenes can be prepared by the addition of a dibromocarbene to a 1,2-disubstituted-1-bromoethylene which forms a 1,2-disubstituted-1,3,3-tribromocyclopropane. Subsequent treatment of the 1,2-disubstituted-1,3,3-tribromocyclopropane with methyllithium provides the desired 1,2-disubstituted cyclopropene. Alternatively, 1,2-disubstituted cyclopropenes can be prepared by deprotonating a 1-substituted cyclopropene with butyllithium and then alkylating with an appropriate bromide or iodide, preferably in the presence of tetramethylethylenediamine.

Cyclopropenes substituted in the 3-position can be prepared in a manner analogous to the preparation of a 1-substituted cyclopropene through addition of a dibromocarbene to a 2-substituted vinyl bromide which forms a 3-substituted-1,2,2-tribromocyclopropane. Subsequent treatment of the 3-substituted-1,2,2-tribromocyclopropane with methlylithium provides the desired 3-substituted cyclopropene.

3,3-Disubstituted cyclopropenes can be prepared by the method of Binger, P., Synthesis, (1974), 190. This method comprises addition of a dibromocarbene to a 1,1-disubstituted ethylene which forms a 1,1-disubstituted-2,2-dibromocyclopropane. Subsequent reduction of the 1,1-disubstituted-2,2-dibromocyclopropane with zinc dust provides a 1,1-disubstituted-2,2-dibromocyclopropane which, following elimination with potassium tert-butoxide, provides the desired 3,3-disubstituted cyclopropene.

Example compounds of this invention were made according to the following procedures:

Compound 1 (1-methylcyclopropene) was prepared using the procedure of U.S. Pat. No. 5,518,988 by reacting, in an inert environment, sodium amide with 3-chloro-2-methylpropene. The 1-methylcyclopropene produced was then formulated by encapsulation in α-cyclodextrin (0.14% by weight) using the procedure of U.S. Pat. No. 6,017,849.

Compound 2 (1-n-octyl-3,3-difluorocyclopropene) was prepared by the reaction of (bromodifluoromethyl)triphenylphosphonium bromide and potassium fluoride with 1-decyne according to the method of Bessard, Y. and Schlosser, M., Tetrahedron (1991), 47(35) 7323-8.

### EXAMPLE 1—Activity Against Botrytis cinerea

Compounds were evaluated for the ability to inhibit germination of Botrytis cinerea spores using an assay which measures the inhibition of germination-associated adhesion in microtiter plates.

Encapsulated compound 1 (1-methylcyclopropene) was dissolved in Sabouraud dextrose broth (“SDB”, obtained from Difco Laboratories) at a concentration of 500 ppm. Compound 2 (1-n-octyl-3,3-difluorocyclopropene) was dissolved in DMSO at 50 mg/ml. This solution was then diluted with SDB to give a solution concentration of compound 2 of 1000 ppm. Comparison compound, AVG, was dissolved in SDB at 5 mg/ml. Two-fold serial dilutions of the solutions of these compounds in SDB were made in 100 μl aliquots of SDB in 96-well microtiter plates. Spore suspension of B. cinerea (100 μl at 2×10⁵ spores/ml) was added to the wells. The plates were then incubated at 25° C. for 5.5 hours at which time spores in control wells had germinated. The medium containing unbound spores was removed by inverting and flicking the microtiter plate to remove as much liquid as possible. Quantitation of the adhered spores was achieved by measuring their cellular protein content using sulforhodamine B (see Skehan et al., Journal of the National Cancer Institute, 82, 1107-1112 (1990)), measuring absorbance at 564 nm. Inhibition of adhesion was determined by comparing the absorbance value in a well containing fungicide with the absorbance in control wells without fungicide. EC₅₀ values for germination inhibition were determined from dose-response curves. The results of this test are in Table 1.

TABLE 1

| Compound | EC₅₀ (ppm) |
|---|---|
| 1 | 37 |
| 2 | 3.3 |
| Comparison (AVG) | >2,500 |

A solution of α-cyclodextrin alone had no activity at 50 mg/ml.

### EXAMPLE 2—Activity Against Various Fungi

Compound 1 was tested for in vitro fungitoxicity towards a variety of fungi. The compound was encapsulated in α-cyclodextrin (0.14% by weight) which was dissolved in yeast-extract/glucose medium (“YEG” made from 20 g of glucose and 4 g of yeast extract per liter of water) to give a concentration of compound 1 of 430 ppm. Two-fold serial dilutions were prepared in 100 μl aliquots of YEG medium in 96-well microtiter plates. The wells were inoculated with the various fungi prepared in YEG as either spore suspensions (Septoria nodorum, Colletotrichum lagenarium, Pyricularia oryzae, and Phytophthora capsici) or as mycelial homogenates (Pythium ultimum and Rhizoctonia solani). Mycelial growth was assessed by measuring absorbance at 570 nm after growth at 25° C. for 2 days (S. nodorum and P. ultimum) or 5 days (C. lagenarium, P. oryzae, P. capsici, and R. solani). EC₅₀ values were determined from dose-response curves obtained. The results of this experiment are in Table 2.

TABLE 2

| Organism | EC₅₀ (ppm) |
|---|---|
| Pythium ultimum | 2.6 |
| Pyricularia oryzae | 6.7 |
| Phytophthora capsici | 6.9 |
| Rhizoctonia solani | 7.4 |
| Septoria nodorurn | 22.5 |
| Colletotrichum lagenarium | >70 |

A solution of α-cyclodextrin alone had no activity at 30 mg/ml.

### EXAMPLE 3—Technical Material v. Formulation

The above examples demonstrate fungitoxicity of compound 1 when provided as encapsulated material in α-cyclodextrin. Since compound 1 is a gas at room temperature its activity as a technical material in solution was evaluated in sealed vials with a small head space as follows. Compound 1, formulated by encapsulation in a-cyclodextrin, was also tested for comparison.

Compound 1 (technical material) was added to 21×50 mm glass vials on dry ice as the appropriate amount of a 14% (w/v) solution in acetone to provide the desired concentrations. (The acetone solutions were kept on dry ice or in a freezer at −80° C. until used.) Controls received the same volumes of acetone alone. A spore suspension (8 ml) of Botrytis cinerea at 2.5×10⁴ spores/ml in two-fold diluted SDB was added to each vial. The vials were immediately sealed with polyethylene plugs and placed in a 250° C. incubator for 16 hours. The extent of fungal growth in the vials was determined by measuring their cellular protein content using sulforhodamine B (Skehan, et al., Journal of the National Cancer Institute 82, 1107-1112 (1990)), and the percent inhibition of growth was calculated by comparing growth in the treatments with growth in the controls.

The desired amounts of Compound 1, formulated by encapsulation in α-cyclodextrin (4% by weight) were added to glass vials. A spore suspension (8 ml) of Botrytis cinerea at 2.5×10⁴ spores/ml in two-fold diluted SDB was added to each vial, and vials processed as described above. Values for percent inhibition of growth are presented in the table below. α-Cyclodextrin alone did not cause any inhibition of growth.

| | Conc. | % Inhibition |
|---|---|---|
| Treatment | (ppm) | of growth |
| Cpd. 1, technical material | 175 | 30.1 |
| | 350 | 99.4 |
| | 525 | 99.8 |
| Cpd. 1, α-cyclodextrin formulation | 40 | 14.1 |
| | 80 | 43.8 |
| | 160 | 99.5 |
| | 200 | 99.5 |

### Example 4—Suppression of Botrytis rot on rose petals

Freshly cut white roses were purchased from Zieger & Sons, Inc. rose growers. Non senescing petals were chosen to perform the experiment. Petals were placed in plastic petri dishes (100×20 mm) each containing a moist #3 Whatman filter paper with one petal per petri dish.

Compound 1, formulated as in Example 1 (0.778 g) was dissolved in 20 ml hot water in a 100 ml jar sealed with a cap. When the powder was dissolved, the jar was placed in a 4.8 liter cabinet containing three petri dishes (without the lids) with petals. The cap of the jar was quickly removed and the cabinets sealed for ninety (90) minutes. The concentration of Compound 1 in the gas phase was 100 ppm.

After exposure to Compound 1 at 100 ppm the petals were inoculated with two 20μl drops of spore suspension containing 1×10⁶ spores per ml. Controls were inoculated without prior exposure to Compound 1.

Lids were placed on the petri dishes and the dishes were transferred to a plant growth chamber set at a 12 hour photoperiod, a 20° C. day temperature and 18° C. night temperature, and 70% relative humidity to allow disease development. The number of petals with sporulating lesions was determined after 10 days. Two trials were conducted with 3 petals per treatment in each trial. The combined results from the two trials were as follows:

| | Petals with |
|---|---|
| | sporulating lesions |
| Treatment | (%) |
| Compound 1 | 16.7 |
| (100 ppm) | |
| control | 66.7 |

These data demonstrate the fungitoxic activity of the compounds of this invention and their ability to control fungal disease.

The compounds of this invention are useful as agricultural fungicides and, as such, can be applied to various loci such as plant seed, the soil where plants to be protected grow, or the foliage of plants to be protected. Certain compounds of this invention which are gases at temperatures used for the particular application can be applied to the plant in a sealed area by release of the compound as a gas.

The compounds of this invention can also be applied as fungicidal sprays by methods commonly employed, such as conventional high-volume hydraulic sprays, low-volume sprays, air-blast spray, aerial sprays and dusts. The dilution and rate of application will depend upon the type of equipment employed, the method of application, plants to be treated and diseases to be controlled. Generally, the compounds of this invention will be applied in amount of from about 0.005 kilogram to about 50 kilograms per hectare and preferably from about 0.025 to about 25 kilograms per hectare of the active ingredient.

As a seed protectant, the amount of toxicant coated on the seed is usually at a dosage rate of from about 0.05 to about 20, preferably from about 0.05 to about 4, and more preferably from about 0.1 to about 1 grams per hundred kilograms of seed. As a soil fungicide the chemical can be incorporated in the soil or applied to the surface usually at a rate of from about 0.02 to about 20, preferably from about 0.05 to about 10, and more preferably from about 0.1 to about 5 kilograms per hectare. As a foliar fungicide, the toxicant is usually applied to growing plants at a rate of from about 0.01 to about 10, preferably from about 0.02 to 5, and more preferably from about 0.25 to about 1 kilograms per hectare.

Inasmuch as the compounds of this invention display fungicidal activity, these compounds can be combined with other known fungicides to provide broad spectrum activity. Suitable fungicides include, but are not limited to, those compounds listed in U.S. Pat. No. 5,252,594 (see in particular columns 14 and 15). Other known fungicides which can be combined with the compounds of this invention are dimethomorph, cymoxanil, thifluzamide, furalaxyl, ofurace, benalaxyl, oxadixyl, propamocarb, cyprofuram, fenpiclonil, fludioxonil, pyrimethanil, cyprodinil, triticonazole, fluquinconazole, metconazole, spiroxamine, carpropamid, azoxystrobin, kresoxim-methyl, metominostrobin and trifloxystrobin.

The compounds of this invention can be advantageously employed as fungicides on cereals including wheat, barley and rye, on rice, peanuts, beans and grapes, on turf, on fruit, nuts and vegetables, and for golf course applications. The compounds can be employed in both pre and post harvest applications.

Causal agents of diseases against which the compounds of the invention are useful include Botrytis spp., Penicillium spp., Cladosporium spp., Phialophora spp., Phytophthora spp., Pezicula spp., Colletotrichum spp., Alternaria spp., Stemphylium spp., Phomopsis spp., Glomerella spp., Mucor spp., Monilinia spp., Rhizopus spp., Mycosphaerella spp., Dothiorella spp., Phoma spp., Sclerotinia spp., Typhula spp., Fusarium spp., Lasiodiplodia spp., Thielaviopsis spp., Saccharomyces spp., Verticillium spp., Nigrospora spp., Aspergillus spp., Geotrichum spp., Pythium spp., Helminthosporium spp., Venturia spp., Septoria spp., Pyricularia spp., and fungi which cause powdery mildew and rust diseases.

We claim:

1. A method to control phytopathogenic fungi, comprising applying to the locus of the fungi a fungicidally effective amount of a compound of the formula: 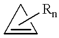
wherein:
a) n is from 1 to 4, preferably from 1 to 2, more preferably 1; and
b) each R is independently hydrogen, cyano; halogen, hydroxy; carboxy;
(C₁-C₂₀)alkyl, optionally substituted independently with from 1 to 3 halogen, hydroxy, cyano, (C₁-C₂₀)alkoxy, or amino; (C₁-C₂₀)alkoxy, optionally substituted independently with from 1 to 3 halogen, hydroxy, cyano, (C₁-C₂₀)alkoxy, or amino; (C₂-C₂₀)alkenyl, optionally substituted independently with from 1 to 3 halogen, hydroxy, cyano, (C₁-C₂₀)alkoxy, or amino; (C₂-C₂₀)alkynyl, optionally substituted independently with from 1 to 3 halogen, hydroxy, cyano, (C₁-C₂₀)alkoxy, or amino; (C₁-C₂₀)alkoxycarbonyl(C₁-C₂₀)alkyl, optionally substituted independently with from 1 to 3 halogen, hydroxy, cyano, (C₁-C₂₀)alkoxy, or amino; or amino; provided that the total number of non-hydrogen atoms in each R does not exceed 21; and
its enantiomers, stereoisomers, and agronomically acceptable salts; or a composition comprising one or more of the compounds and an agronomically acceptable carrier.

2. The method of claim 1, wherein n is from 1 to 2.

3. The method of claim 1, wherein n is 1.

4. The method of claim 1, wherein n is 2 and the R groups are in the 1,2-position on the cyclopropene ring.

5. The method of claim 1, wherein n is 2 and the R groups are both in the 3-position on the cyclopropene ring.

6. The method of claim 1, wherein each R is independently hydrogen, cyano; halogen, hydroxy; carboxy; (C₁-C₁₀)alkyl, optionally substituted independently with from 1 to 3 halogen, hydroxy, cyano, (C₁-C₁₀)alkoxy, or amino; (C₁-C₁₀)alkoxy, optionally substituted independently with from 1 to 3 halogen, hydroxy, cyano, (C₁-C₁₀)alkoxy, or amino; (C₂-C₁₀)alkenyl, optionally substituted independently with from 1 to 3 halogen, hydroxy, cyano, (C₁-C₁₀)alkoxy, or amino; (C₂-C₁₀)alkynyl, optionally substituted independently with from 1 to 3 halogen, hydroxy, cyano, (C₁-C₁₀)alkoxy, or amino; (C₁-C₁₀)alkoxyearbonyl(C₁-C₁₀)alkyl, optionally substituted independently with from 1 to 3 halogen, hydroxy, cyano, (C₁-C₁₀)alkoxy, or amino; or amino; provided that the total number of non-hydrogen atoms in each R does not exceed 11.

7. The method of claim 1, wherein each R is independently (C₁-C₁₀)alkyl; (C₁-C₁₀)alkoxy; (C₂-C₁₀)alkenyl; or (C₂-C₁₀)alkynyl.

8. The method of claim 3, wherein the R group is in the 1-position on the cyclopropene ring and the R group is (C₁-C₁₀)alkyl.

9. The method of claim 1, wherein the locus of the fungi is plant seed, the soil where plants to be protected grow, or the foliage of plants to be protected.

10. The method of claim 1, wherein the phytopathogenic fungi to be controlled are one or more of Botrytis spp., Penicillium spp., Cladosporium spp., Phialophora spp., Phytophthora spp., Pezicula spp., Colletotrichum spp., Alternaria spp., Stemphylium spp., Phomopsis spp., Glomerella spp., Mucor spp., Monilinia spp., Rhizopus spp., Mycosphaerella spp., Dothiorella spp., Phoma spp., Sclerotinia spp., Typhula spp., Fusarium spp., Lasiodiplodia spp., Thielaviopsis spp., Saccharomyces spp., Verticillium spp., Nigrospora spp., Aspergillus spp., Geotrichum spp., Pythium spp., Helminthosporium spp., Venturia spp., Septoria spp., Pyricularia spp., and fungi which cause powdery mildew and rust diseases.
